(19) United States
(12) Patent Application Publication
(10) Pub. No.: US 2015/0226303 A1
(43) Pub. Date: Aug. 13, 2015

(54) GEAR

(71) Applicant: Miba Sinter Austria GmbH, Laakirchen (AT)

(72) Inventor: Christian DUMANSKI, Plesching - Steyregg (AT)

(73) Assignee: Miba Sinter Austria GmbH, Laakirchen (AT)

(21) Appl. No.: 14/616,391

(22) Filed: Feb. 6, 2015

(30) Foreign Application Priority Data
Feb. 13, 2014 (AT) A 50107/2014

(51) Int. Cl. F16H 55/18; F16H 55/17

(52) U.S. Cl. CPC F16H 55/18; F16H 55/17

(57) ABSTRACT

The invention relates to a gear (1) comprising a first, radially inner ring element (2) with a first ring element axis (9) in axial direction, a second, radially outer ring element (3) with a second ring element axis (8) in axial direction and a connecting element (4), wherein the second ring element (2) comprises a toothing (6) with teeth (7) that is rotatable about a rotational axis, wherein furthermore the connecting element (3) is arranged in radial direction between the first ring element (2) and the second ring element (3) and is connected to the latter, and wherein the connecting element (4) is made at least partly from a rubber-elastic material. The first ring element axis (9) runs in the axial direction of the first, radially inner ring element (2) or the rotational axis of the toothing (6) runs in radial direction offset relative to the second ring element axis (8) in axial direction of the second, radially outer ring element (3) and/or the toothing (6) is configured to have unevenly shaped teeth (7).

The invention relates to a gear comprising a first, radially inner ring element with a first ring element axis in axial direction, a second, radially outer ring element with a second ring element axis in axial direction and a connecting element, the second, radially outer ring element comprising a toothing with teeth that is rotatable about a rotational axis, furthermore the connecting element being arranged in radial direction between the first, radially inner ring element and the second, radially outer ring element and connected to the first, radially inner ring element and the second, radially outer ring element, and the connecting element being made at least partly of a rubber-elastic material.

In order to offset the play of the tooth flank gears are known from the prior art that are divided in axial direction. A gear arrangement of this kind is known for example from WO 2005/090830 A1 of the Applicant with a gear for a play-free spur gear stage with a hub, with a gear rim supported by the hub, which is divided along an axially normal partition plane into two part rims, namely into a rim part secured to the hub and a rim ring mounted coaxially rotatably in relation to the latter, and with an annular spring enclosing the hub, which is supported at its opposite ends in peripheral direction on support webs formed in one piece with the two part rings and overlapping one another in axial direction, which support webs are arranged behind one another in peripheral direction of the gear rim.

Furthermore, gears are known from the prior art that are also divided in radial direction for the purpose of damping the vibrations and noise of machine components. For example DE 71 35 220 U1 describes a vibrationally damped gear wheel with an inner part which has an annular groove on its outer casing surface, a ring-shaped outer part arranged concentrically and a distance from the inner part, which outer part also has an annular groove on its inner casing surface, which together with the annular groove arranged on the inner part forms an annular space into which a rubber elastic profile ring connecting the inner and outer part is inserted in a non-rotatable manner, the non-deformed radial extension of which is greater than that of the annular space formed between the inner and outer part, wherein at least one of the two annular grooves preferably comprises extensions arranged at regular intervals.

Similar gears are described in U.S. Pat. No. 2,307,129 A, U.S. Pat. No. 4,674,351 A, EP 2 623 820 A, DE 31 53 109 C2 and DE 602 05 710 T2.

However, it is also known to install such radially divided gears in an axially divided gear to eliminate play.

For example DE 10 2011 120 676 A1 describes a gear with an inner ring element and an outer ring element, wherein a toothing is formed on the outer periphery of the outer ring element, wherein the inner ring element and the outer ring element are joined together by a vulcanized elastomer portion, such that the ring elements can be moved elastically relative to one another in radial direction. Said gear is arranged on the hub of a further gear, as described above.

Similar gear arrangements are also described in DE 10 2011 120 266 A1 and DE 10 2009 015 958 A1.

The basic objective of the present invention is to make it possible to eliminate the play of two meshing gears.

Said objective is achieved in the aforementioned gear in that the first ring element axis runs in the axial direction of the first, radially inner ring element or the rotational axis of the toothing in radial direction offset relative to the second ring element axis in axial direction of the second, radially outer ring element and/or the toothing is designed to have unevenly shaped teeth.

The advantage here is that it is no longer necessary to divide the gear in axial direction, which simplifies the structure with regard to eliminating play between gear pairings. In this way the assembly of the gear pairing is also simplified, as the gear rim is usually pretensioned in axially divided gears and is secured in this position. After installation the position securing means is removed, whereby the toothing of the divided gear engages in a play-free manner in the toothing of the second gear. A securing element of this kind and the pretensioning performed by the manufacturer of the gear are not necessary with the gear according to the invention. By designing the gear to be undivided in axial direction it is also possible to bring the whole toothing width of the gear into engagement with the toothing of the additional gear. It is thus possible to reduce the axial width of the gear, whereby the axial installation depth can be reduced. Furthermore, by means of the the gear also a gear pairing can be provided with a low weight compared to a gear pairing of the prior art but with the same functionality.

The uneven toothing can be configured in the form of a toothing designed to be eccentric to the first ring element axis in axial direction of the first, radially inner ring element. This has the advantage that the connecting element can be designed to have a uniform thickness in radial direction, whereby fewer oscillations are produced in the gear. In this way the noise produced by the gear during the meshing engagement of the toothing with the toothing of the further gear can be reduced so that overall the gear pairing is quieter during operation. It is thus also possible to reduce the stress of the connecting areas between the two ring elements and the connecting element.

To avoid having an eccentric arrangement of the second, radially outer ring element relative to the first, radially inner ring element, according to another embodiment variant of the gear the teeth can be configured to have a different tooth thickness in peripheral direction and/or the teeth can be provided with flank crowning, whereby the flank crownings of the teeth vary and/or the gear pitch varies over the periphery of the toothing. This is an advantage with regard to the eccentric configuration of the toothing. It is also an advantage that said geometric configurations of the toothing can be represented relatively simply.

In the gear it is also possible to have a wall thickness in radial direction between the radially innermost edge and the root diameter of the toothing of the second, radially outer ring element that is at least as large as half the tooth height of the teeth of the toothing. In this way the mechanical stress of the connecting element can be reduced by the more even distribution of stress in the second, outer ring element, in particular in the embodiment variant of the gear with the second, radially outer ring element offset eccentrically relative to the first, radially inner ring element.

According to another embodiment variant of the gear it is possible that edges of the first, radially inner ring element in the connecting area between the first, radially inner ring element and the connecting element and edges in the connecting area between the second, radially outer ring element and the connecting element are provided with a rounding. It is an advantage that the durability of the gear can be improved in this way, in particular of the connecting element. By forming round edges on the radially inner and the radially outer ring element it is possible to avoid the point-like overloading of the connecting area on the edges and thereby prevent the connecting element from tearing off more effectively. In this way the continually changing compressive and tensile loads on the connecting element can be absorbed by the latter more effectively. Furthermore, a notching effect can be prevented on the edges. It is thus possible to design the connecting element in a simple manner with respect to its geometry. By means of the rounding the areas available for connecting the radially inner ring element and the radially outer ring element with the connecting element are increased, whereby the durability can also be improved. By rounding the edges it is also possible that in a flush configuration of the connecting element relative to the axial end faces of the two ring elements, the connecting element surrounds the ring elements radially in the connecting area, whereby compressive and tensile loads on the gear in axial direction can also be absorbed more effectively. As a secondary effect the rounded edges have the advantage that the two ring elements can be demolded more easily, if the latter are made of sintered materials.

Furthermore, it is also possible for the connecting element to project in axial direction over the first, radially inner ring element and the second, radially outer ring element and partly overlaps in radial direction the first, radially inner ring element and/or the second, radially outer ring element. In this way a further improvement of the connection between the connecting element and the two ring elements is achieved, whereby subsequently the durability of said connection can be improved.

For a better understanding of the invention the latter is explained in more detail with reference to the following Figures.

In a simplified, schematic representation:

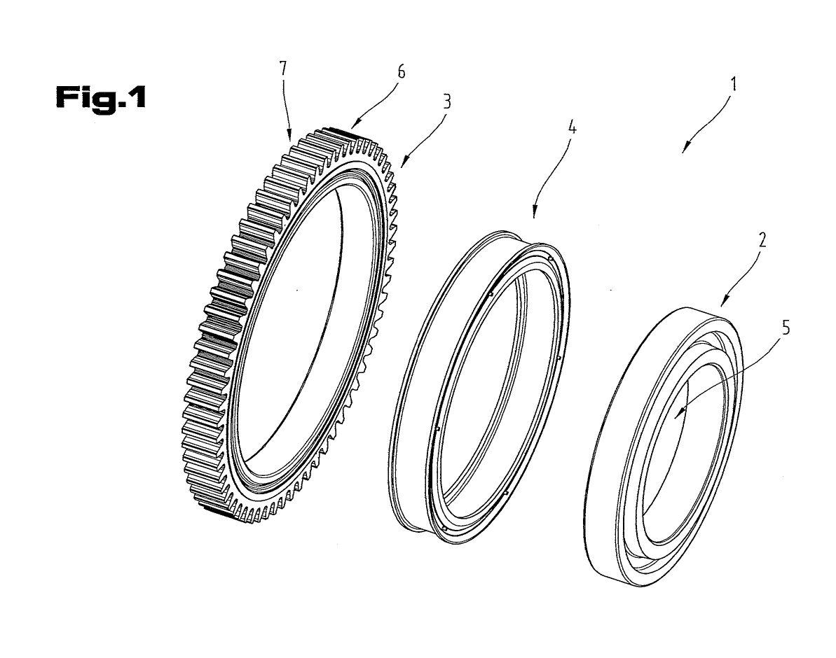

FIG. 1 is a first embodiment variant of the gear in an exploded view;

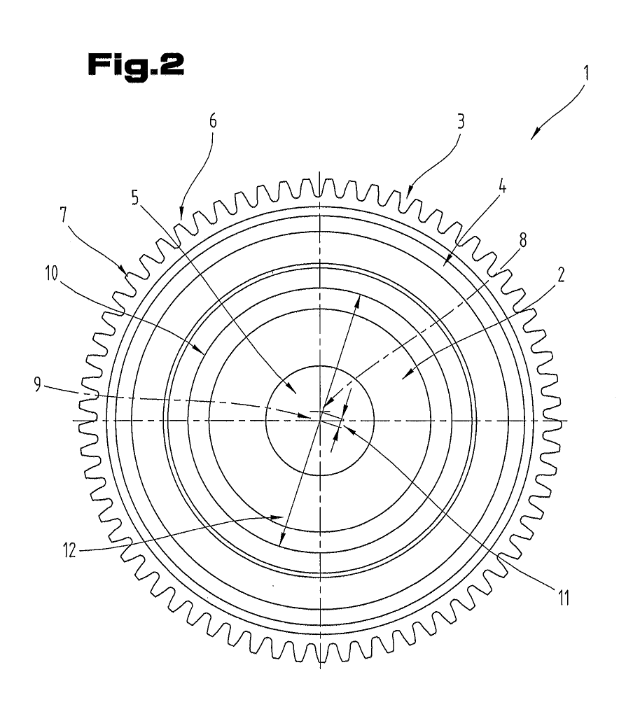

FIG. 2 is the gear according to FIG. 1 in a view of an axial end face;

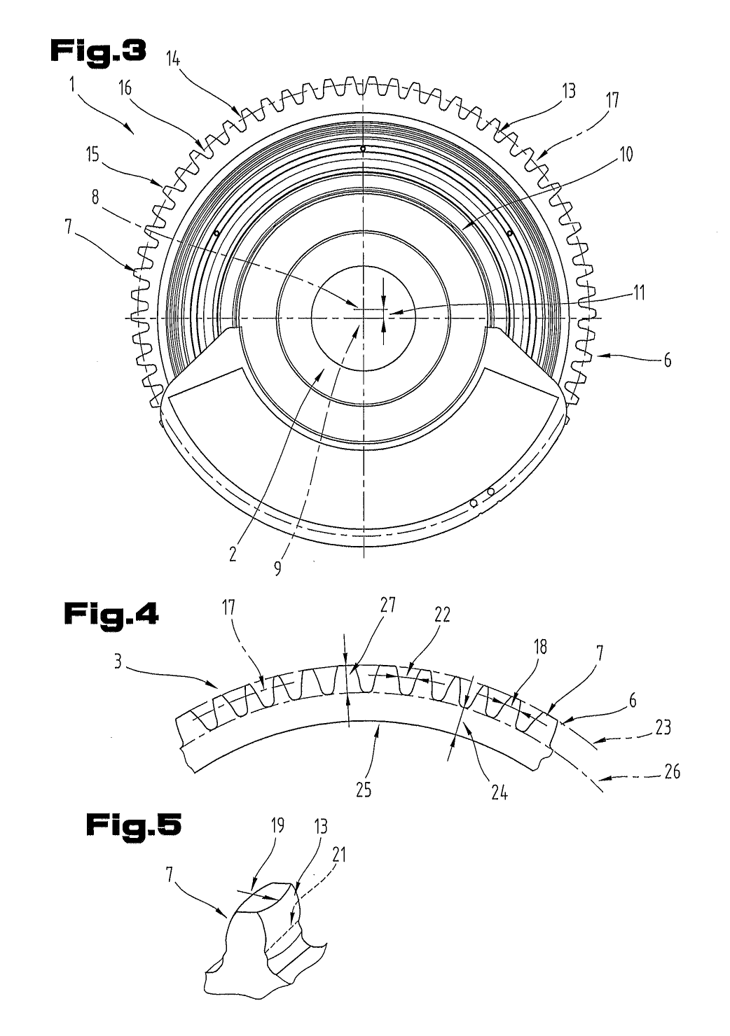

FIG. 3 is an embodiment variant of the gear in a view of an axial end face;

FIG. 4 is a section of the second, radially outer ring element of an embodiment variant of the gear in a view of an axial end face;

FIG. 5 is a tooth of the toothing of the second, radially outer ring element of an embodiment variant of the gear in an oblique view;

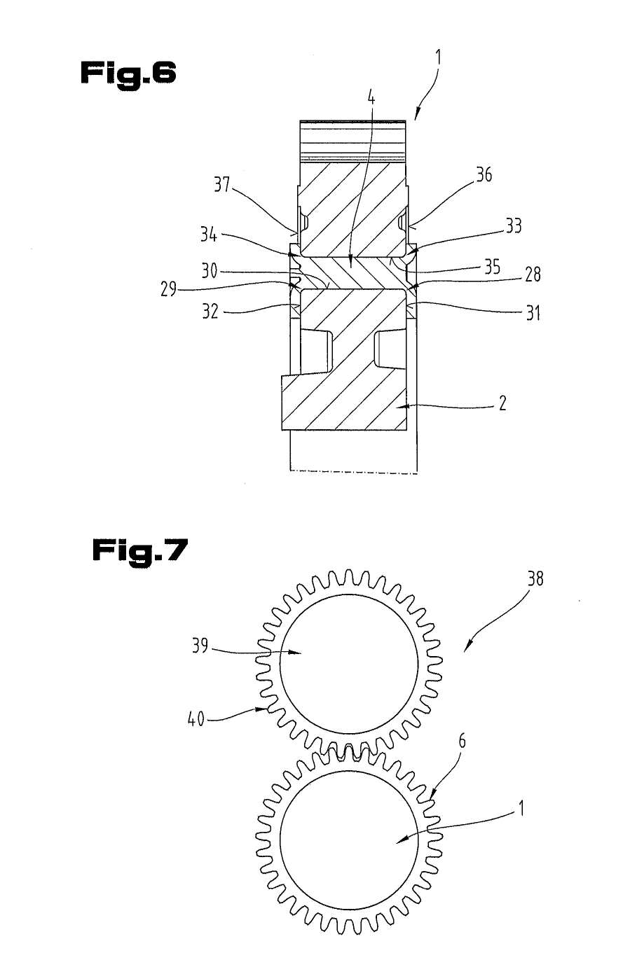

FIG. 6 is a cut-out of another embodiment variant of the gear in a side view in cross section;

FIG. 7 is a play-free gear pairing with a gear according to the invention, which is in meshing engagement with another gear.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position.

In FIGS. 1 and 2 a first embodiment variant of a gear 1 is shown. The gear 1 consists of or comprises a first, radially inner ring element 2, a second, radially outer ring element 3 and a connecting element 4. The first, radially inner ring element 2 can also be denoted as a hub part and the second, radially outer ring element 3 can be denoted as a gear rim.

The first, radially inner ring element 2 and/or the second, radially outer ring element 3 are preferably made from a metal material, for example steel, preferably a sintered material, for example a sintered steel. However other metal materials can also be used for the radially inner ring element 2 and/or the radially outer ring element 3, wherein the radially inner ring element 2 and/or the radially outer ring element 3 can also consist of at least two different metal materials.

The connecting element 4 is made at least partly of a rubber-elastic material, for example an (X)NBR ((carboxylated) acrylonitrile-butadiene-rubber), HNBR (hydro-genated nitrile-rubber), a silicon-rubber (VMQ), NR (natural rubber), EPDM (ethylene-propylene-diene-rubber), CR (chloroprene-rubber), SBR (styrene-butadiene rubber) etc., wherein mixtures of materials can also be used.

The term “at least partly” means that for example reinforcing elements, such as e.g. fibers and/or threads, can be embedded in the connecting element 4, for example made of metal, plastic, natural fibers etc. or rods. Preferably, the connecting element 4 is made solely from a rubber-elastic material.

The first, radially inner ring element 2 comprises a recess 5 running in axial direction, in particular a bore. In this way the first, radially inner ring element 2 can be arranged on a not shown shaft.

The second, radially outer ring element 3 comprises a toothing 6 with teeth 7 on the radially outer end face. Said toothing 6 can have a form adjusted to the respective application of the gear 1, for example for the configuration of a gear wheel. Furthermore, the toothing 6 can extend in axial direction of the gear 1 over the whole width of the second, outer ring element 3 or only over a portion of said width.

The second, radially outer ring element 3 is arranged in radial direction above the first, radially inner ring element 2.

The connecting element 4 is arranged between the first, radially inner ring element 2 and the second, radially outer ring element 3. The first, radially inner ring element 2 and the second, radially outer ring element 3 are connected to said connecting element 4 to form the gear 1 with one another.

As shown best in FIG. 2 a ring element axis 8 is arranged offset in axial direction of the radially second ring element 3 (in FIG. 2 indicated by a cross) in radial direction relative to a ring element axis 9 in axial direction of the radially first ring element 2 (indicated in FIG. 2 by a cross). In other words the second, radially outer ring element 3 is arranged to be eccentric, i.e. not coaxial to the first, radially inner ring element 2.

In order to achieve the eccentricity an outer periphery 10 of the first, radially inner ring element 2 can deviate from circular geometry, for example with a bulge in radial direction on one side (i.e. almost cam-like).

However, the eccentricity can also be achieved in this embodiment variant by means of the connecting element 4. This is mainly because the connecting element 4 is preferably produced by vulcanization, in particular hot vulcanization, on the first, radially inner ring element 2 and the second, radially outer ring element 4. The eccentricity can be achieved in that the second, radially outer ring element 3 is positioned with an offset of its ring element axis 8 relative to the ring element axis 9 of the first, radially inner ring element 2, and then a rubber mass is inserted into the gap between the two ring elements 2, 3 and vulcanized. This has the advantage that the two ring elements 2, 3 are configured to have a circular ring-shaped geometry and thus can be produced more easily.

A radial distance 11 of the first ring element axis 9 from the second ring element axis 8 can be selected from a range of 0.01 mm and 1 mm.

The tooth thickness within the meaning of the invention and in technical terms is defined as the width of the tooth at the level of the pitch circle, wherein the pitch circle is the circle with a diameter at which the values for the thickness of the teeth and the width of the gaps of a toothing are of equal size.

According to one embodiment variant of the gear 1 according to FIGS. 1 and 2 it is also possible for the first, radially inner ring element 2 and the second, radially outer ring element 3 to be arranged concentrically to one another so that the two ring element axes 8, 9 cover one another. In order to achieve eccentricity in this embodiment variant it is possible that only the toothing 6 is designed to be eccentric to the two ring element axes 8, 9. In this way a rotational axis of the toothing 6, about which the teeth 7 rotate during the rotation of the gear 1, unlike the ring element axes 8, 9 i.e. said rotational axis, is radially offset to the ring element axes 8, 9 running in axial direction. The rotational axis can also be offset by the distance 11, as already explained above, in radial direction relative to the ring element axes 8, 9, so that in this case in the present embodiment variant the cross, which in FIG. 2 represents the ring element axis 9 of the second, radially outer ring element 3, represents the rotational axis of the toothing 6.

In other words the rotational axis of the gear 1 itself, which is congruent with the ring element axis 8, and the axis in axial direction through the center of gravity of the gear 1 do not coincide, but said center of gravity axis is offset by distance 11 in radial direction in relation to the ring element axis 8.

Said embodiment variant of the gear 1 can be produced for example such that in a first step the two ring elements 2, 3 are arranged coaxially to one another and are connected to the connecting element 4, and in that a further step the toothing 6 is ground eccentrically to the ring central axis 8.

In the following FIGS. 3 to 6 further and possibly independent embodiments of the gear 1 are shown (partly only sections of the gear 1 are shown), whereby for the same parts the same reference numbers or component names are used as for the preceding FIGS. 1 and 2. To avoid unnecessary repetition reference is made to the detailed description of the preceding FIGS. 1 and 2.

Alternatively or in addition to the aforementioned embodiment variant of the gear 1 it is also possible for the toothing 6 to be designed to have unevenly shaped teeth 7.

In addition according to a first embodiment variant of the unevenly formed teeth 7, the toothing 6 can be designed to be eccentric to the first ring element axis 9 in axial direction of the first, radially inner ring element 2.

To produce the eccentrically designed toothing 6 the teeth 7 can be machined, in particular ground eccentrically. In this case preferably only one tooth flank 13 or both tooth flanks 13, 14 of the teeth 7 are ground. Tooth tips 15 and/or tooth gaps 16 are preferably not machined, whereby it is possible to also machine the tooth tips 15 and/or the tooth flanks 16, in particular grind them.

As the eccentric grinding of toothings is known from the prior art, it is not explained in more detail here and reference is made to the relevant prior art on grinding toothings.

For grinding the toothing the second ring element axis 8 is fixed in a grinding machine displaced in axial direction of the second, radially outer ring element 3 from being concentric to the first ring element axis 9 in radial direction (as indicated in FIG. 3). In this way a pitch circle 17 of the toothing (the definition of the pitch circle 17 is defined above) in the finished gear 1 runs eccentrically, i.e. not coaxially, to the periphery 10 of the first, radially inner ring element 2.

The radial distance 11 between the first ring element axis 9 in axial direction of the first, radially inner ring element 2 and the middle point of the pitch circle 17 can be selected for grinding the toothing 6 from the aforementioned range for the distance 11.

The second, radially outer ring element 3 is then arranged in the gear 1 such that the gear is aligned according to the center of gravity unbalance ±3 teeth 7.

Instead of grinding any other suitable kind of material-removing processing of the toothing 6 can be applied.

Preferably, the toothing 6 is formed by a value eccentric to the first ring element axis 9 in axial direction of the first, radially inner ring element 2, which is selected from a range of 0.01 mm to 1 mm, relative to the axis of rotation of the gear 1.

Alternatively or in addition to the aforementioned embodiment variants of the gear 1 in order to configure the unevenly shaped teeth 7 of the toothing 6 it is possible for the teeth 7 to be designed with varying tooth thicknesses 18 in peripheral direction, as shown in a section in FIG. 4, which shows a section of the second, radially outer ring element 3.

The tooth thickness 18 of the individual teeth 7 can be changed by a value selected from a range of 10% to 100% of the tooth thickness 18 of the tooth 7 with the smallest tooth thickness 18.

It is possible for the toothing 6 to have a sequence of thicker and thinner teeth 7, wherein a thinner tooth 7 follows a thicker tooth 7. The toothing 6 can in this case only comprise teeth with two different tooth thicknesses 18.

However, it is also possible to configure the teeth 7 of the toothing to have a plurality of different tooth thicknesses 18, for example three, four, five, six etc., so that a greater variation in the tooth thicknesses 18 can be given to the toothing 6. The arrangement can be such for example that two or more thinner teeth 7 are arranged next to one another followed by a thicker tooth 7 or a plurality of thicker teeth 7, as shown by way of example in FIG. 4.

It is also possible for the thickness 18 of the teeth 7 to increase continually in peripheral direction over the area of a circle segment and to decrease continually over a further area of an adjoining circle segment, wherein also a plurality of areas can be arranged one after the other with the continual increase and subsequently continual reduction of the tooth thickness 18 in peripheral direction. For example, two or three or four or five areas can be arranged with a continual increase of the tooth thickness 18, which can be separated from one another respectively in peripheral direction from one area with a continual reduction in the tooth thickness 18. The tooth thickness 18 can be increased by a maximum value selected from a range of 5% of the tooth thickness 18 of the thinnest tooth 7 to 100% of the tooth thickness 18 of the thinnest tooth 7. The same applies to the reduction of the tooth thickness 18.

According to a further embodiment variant of the gear 1 the teeth can be provided with a flank crowning, the flank crowning of the teeth being variable. FIG. 5 shows a tooth 7 with a flank crowning. The variable flank crowning can thereby be configured such that a radius of the flank crowning is varied.

With regard to the sequence of teeth 7 with variable flank crowning reference is made to the aforementioned explanations regarding the variable tooth thickness 18, which can be applied accordingly.

In addition, it is also the case, as shown in FIG. 5, that the flank crowning of at least one tooth flank 13 is designed to be asymmetrical within a tooth 7, so that for example a recessed area 20 of the flank crowning runs in a direction which is at an angle to the axial direction of the gear 1.

According to another embodiment variant of the gear 1 the gear pitch can vary over the periphery of the toothing.

The gear pitch denotes a distance 22 from one tooth 7 to the next at the level of the pitch circle 17.

Said embodiment variant is also represented in FIG. 4.

It should be noted at this point that in the design of teeth 7 with a different tooth thickness 18 the gear pitch, i.e. the distance 22 between the teeth 7, can also be of equal size.

By means of the eccentric machining of the toothing 6 a wall thickness 24 can also be reduced in radial direction between a radially innermost edge 25 (FIG. 4) and a root diameter 26 of the toothing 6 of the second, radially outer ring element 3. In this case it is preferable if the wall thickness 24 in radial direction between the radially innermost edge 25 and the root diameter 26 of the toothing 6 of the second, radially outer ring element 3 is at least half a tooth height 27 in radial direction of the teeth 7 of the toothing 6. In particular, said wall thickness 24 can be selected from a range of 50% of the tooth height 27 to 150% of the tooth height 27.

As shown in FIG. 6 according to a further embodiment variant of the gear 1, axially outer edges 28, 29 can be designed to be rounded, i.e. provided with a rounding, i.e. the edges 28, 29 in the transitional area from a radially outer end face 30 to axial end faces 31, 32 of the first, radially inner ring element 2 and axially outer edges 33, 34, i.e. the edges 33, 34 in the transitional area from a radially inner end face 35 to axial end faces 36, 37, of the second, radially outer ring element 3.

The radius of the roundings is preferably selected from a range of 0.1 mm to 2 mm, in particular from a range of 0.4 mm to 1.5 mm.

It is possible for the radius of all roundings to be of equal size. However, it is also possible that at least one of the roundings has a different radius from the remaining roundings. For example, the two roundings of the first, radially inner ring element 2 can have a larger radius than the two roundings of the second, radially outer ring element 3. However, it is also possible that the roundings in the region of an axial side of the gear 1, e.g. in the region of the axial end faces 31, 36, have a larger radius, i.e. the roundings of the second axial side of the gear 1, e.g. in the region of the axial end faces 32, 37. By means of said embodiment variants of the gear 1, i.e. the different configuration of the roundings, very different incidences of loading on the gear 1 in axial and radial direction can be taken into consideration.

In the simplest case the roundings 21 to 24 are in the form of part circles, for example quarter circles. However, other configurations of roundings are also possible.

As shown in FIG. 6, the connecting element 4 can project in axial direction over the first, radially inner ring element 2 and the second, radially outer ring element 3 and in radial direction partly overlapping the first, radially inner ring element 2 and/or the second, radially outer ring element 3. The connecting element 4 can thus in particular have an at least approximately H-shaped or an H-shaped cross section.

However, it is also possible for the connecting element 4 to be formed flush with the axial end faces 31, 32 of the first, radially inner ring element 2 and/or flush with the axial end faces 36, 37 of the second, radially outer ring element 3.

Furthermore, the first, radially inner ring element 2 and/or the second, radially outer ring element 3 has or have on at least one of the axial end faces 31, 32 or 36, 37, preferably on all end faces 31, 32, 36, 37, at least one groove, in particular an annular groove, and the connecting element 4 extends into said groove(s).

Alternatively or in addition, the first, radially inner ring element 2 in the end face 30 and/or the second radial, outer ring element 3 in the end face 35 has or have at least one groove, in particular an annular groove, and the connecting element 4 extends into said groove(s).

In this case also a plurality of grooves can be arranged next to one another, so that the end face 30 and/or the end face 35 and/or at least one of the end faces 31, 32 or 36, 37 is or are formed in this area or in these areas in the manner of a toothing.

Furthermore, it is possible instead of grooves to form at least one projection on the end face 30 and/or the end face 35 and/or at least one of the end faces 31, 32 or 36, 37 in this area or these areas in the manner of a toothing.

Furthermore, it is also possible to have a mixed configuration, so that for example at least one groove is formed on the end face 30 of the first, inner ring element 2 and at least one projection is formed on the end face 35 of the second, outer ring element 3 which projects in the direction of the end face 30 over the end face 35.

All of the edges in the region of the groove(s) can also be provided with a rounding for the aforementioned reasons.

To produce the gear 1 the connecting element 4 can be preformed and then connected to the first, radially inner ring element 2 and the second, radially outer ring element 3, for example solely by means of static friction or by the use of a bonding agent, such as e.g. an adhesive.

However, in the preferred embodiment variant of the gear 1 the connecting element 4 is vulcanized in a corresponding form onto the radially inner ring element 2 and the radially outer ring element 3, in particular hot vulcanized.

To improve the formation of the connection it is also possible for individual surfaces at least, in particular all of the surfaces, to be roughened at least in the area of the connection to the connecting element 4, for example by (sand)blasting or grinding, etc.

However, it is also an advantage if at least in the connecting areas open-pored sintered components are used for the first, radially inner ring element 2 and/or the second, radially outer ring element 3, as in this way also a kind of interlocking can be obtained between the connecting element 4 and the first, radially inner ring element 2 and/or the second, radially outer ring element 3.

It can also be an advantage, if at least the faces of the first, radially inner ring element 2 and/or the second, radially outer ring element 3 in the region of the connection to the connecting element 4 are subjected to a plasma pretreatment or plasma activation.

For the sake of completion, FIG. 7 shows a play-free gear pairing 38. The latter consists of or comprises the gear 1 according to the invention and a further gear 39. The toothing 6 of the gear 1 is in engagement with a toothing 40 of the other gear 39 for transmitting a torque. In this case either the gear 1 or the additional gear 39 can be driven and the gear 1 can be driven by the additional gear or the additional gear 39 can be driven by the gear 1.

The example embodiments show possible embodiment variants of the gear 1, whereby it should be noted at this point that various different combinations of the individual embodiment variants are also possible.

Finally, as a point of formality, it should be noted that for a better understanding of the structure of the gear 1 the latter and its components have not been represented true to scale in part and/or have been enlarged and/or reduced in size.

List of Reference Numerals

| | |
|---|---|
| 1 | gear |
| 2 | ring element |
| 3 | ring element |
| 4 | connecting element |
| 5 | recess |
| 6 | toothing |
| 7 | tooth |
| 8 | ring element axis |
| 9 | ring element axis |
| 10 | periphery |
| 11 | distance |
| 12 | diameter |
| 13 | tooth flank |
| 14 | tooth flank |
| 15 | tooth tip |
| 16 | tooth gap |
| 17 | pitch circle |
| 18 | tooth thickness |
| 19 | radius |
| 20 | area |
| 21 | direction |
| 22 | distance |
| 23 | tooth tip circle |
| 24 | wall thickness |
| 25 | edge |
| 26 | root diameter |
| 27 | tooth height |
| 28 | edge |
| 29 | edge |
| 30 | end face |
| 31 | end face |
| 32 | end face |
| 33 | edge |
| 34 | edge |
| 35 | end face |
| 36 | end face |
| 37 | end face |
| 38 | gear pairing |
| 39 | gear |
| 40 | toothing |

1. A gear (1) comprising a first, radially inner ring element (2) with a first ring element axis (9) in axial direction, a second, radially outer ring element (3) with a second ring element axis (8) in axial direction and a connecting element (4), the second, radially outer ring element (2) comprising a toothing (6) with teeth (7) rotatable about a rotational axis, the connecting element (3) being also arranged in radial direction between the first, radially inner ring element (2) and the second, radially outer ring element (3) and being connected to the first, radially inner ring element (2) and the second, radially outer ring element (3), and the connecting element (4) consisting at least partly of a rubber-elastic material, wherein the first ring element axis (9) runs in axial direction of the first, radially inner ring element (2) or the rotational axis of the toothing (6) in radial direction offset relative to the second ring element axis (8) in axial direction of the second, radially outer ring element (3) and/or the toothing (6) is configured to have unevenly shaped teeth (7).

2. The gear (1) as claimed in claim 1, wherein the toothing (6) is designed to be eccentric to the first ring element axis (9) in axial direction of the first, radially inner ring element (2).

3. The gear (1) as claimed in claim 1, wherein the teeth (7) are designed to have a varying tooth thickness (18) in peripheral direction.

4. The gear (1) as claimed in claim 1, wherein the teeth (7) are provided with a flank crowning, the flank crowning of the teeth (7) being variable.

5. The gear (1) as claimed in claim 1, wherein the gear pitch varies over the periphery of the toothing (6).

6. The gear (1) as claimed in claim 1, wherein a wall thickness (24) in radial direction between the radially inner-most edge (25) and a root diameter (26) of the toothing (6) of the second, radially outer ring element (3) is at least the same as half a tooth height (27) of the teeth (7) of the toothing (6).

7. The gear (1) as claimed in claim 1, wherein edges (28, 29) of the first, radially inner ring element (2) are provided in the connecting area between the first, radially inner ring element (2) and the connecting element (4) and edges (33, 34) in the connecting area between the second, radially outer ring element (3) and the connecting element (4) with a rounding.

8. The gear (1) as claimed in claim 1, wherein the connecting element (4) projects in axial direction over the first, radially inner ring element (2) and the second, radially outer ring element (3) and in radial direction partly overlaps the first, radially inner ring element (2) and/or the second, radially outer ring element (3).
